(19) United States
(12) Patent Application Publication
(10) Pub. No.: US 2017/0127713 A1
(43) Pub. Date: May 11, 2017

(54) WHEAT BRAN-CONTAINING PROCESSED FOOD

(71) Applicant: KAO CORPORATION, Tokyo (JP)

(72) Inventors: Asako MITANI, Meridian, ID (US); Mioto SATO, Kita-ku (JP)

(73) Assignee: KAO CORPORATION, Tokyo (JP)

(21) Appl. No.: 15/318,586

(22) PCT Filed: Jun. 23, 2015
(86) PCT No.: PCT/JP2015/068059

§ 371 Date: Dec. 13, 2016

(30) Foreign Application Priority Data
Jun. 27, 2014 (JP) 2014-133357

(51) Int. Cl. A23L 33/21; A21D 13/80; A21D 2/14

(52) U.S. Cl. CPC A23L 33/21; A21D 2/14; A21D 13/80; A23V 2002/00

(57) ABSTRACT

A wheat bran-containing processed food, containing:
insoluble dietary fibers;
ferulic acid; and
p-coumaric acid;
wherein the content of the ferulic acid is 0.035 to 0.16 mass part, with respect to 100 mass parts of the content of the insoluble dietary fibers; and

wherein the content of the p-coumaric acid is 0.004 to 0.06 mass part, with respect to 100 mass parts of the content of the insoluble dietary fibers.

### FIELD OF THE INVENTION

The present invention relates to a wheat bran-containing processed food.

### BACKGROUND OF THE INVENTION

Wheat bran is mainly composed of milled hulls of wheat, and abundantly contains insoluble dietary fibers, vitamins, minerals and the like. Thus, the wheat bran attracts attention as a health food material in recent years. However, when the wheat bran is eaten, the wheat bran absorbs saliva in a mouth, and therefore dry mouth feel remains in the mouth. In combination of this mouth feel with a peculiar odor of the wheat bran and sourness caused by blending the wheat bran, the wheat bran-blending food is generally poor in food taste.

Various techniques for improving the food taste of the wheat bran have been developed so far. For example, Patent Literature 1 describes that flavor of wheat bran has been improved by water-washing and defatting of wheat bran.

Moreover, Patent Literatures 2 to 4 describe that phytic acid in wheat bran can be decreased and mouth feel and flavor of the wheat bran are also improved, by blending wheat bran and water, acting aut-enzyme thereon, and then applying pressure and heat treatment, when necessary.

Further, Patent Literature 5 describes that rough texture and an offensive odor can be suppressed by heating at 100° C. or higher, kneading, shearing, granulating and then milling wheat bran.

### CITATION LIST

### Patent Literatures

Patent Literature 1: JP-A-62-79756 (“JP-A” means unexamined published Japanese patent application)

Patent Literature 2: JP-A-4-23958

Patent Literature 3: JP-A-5-336907

Patent Literature 4: JP-A-5-344866

Patent Literature 5: JP-A-2012-110237

### SUMMARY OF THE INVENTION

The present invention provides a wheat bran-containing processed food, containing: insoluble dietary fibers; ferulic acid; and p-coumaric acid; wherein the content of the ferulic acid is 0.035 to 0.16 mass part, with respect to 100 mass parts of the content of the insoluble dietary fibers; and wherein the content of the p-coumaric acid is 0.004 to 0.06 mass part, with respect to 100 mass parts of the content of the insoluble dietary fibers.

Other and further objects, features and advantages of the invention will appear more fully from the following description.

### MODE FOR CARRYING OUT THE INVENTION

In the inventions described in the above-described Patent Literatures 1 to 5, the odor or mouth feel, which is regarded as a disadvantage of the wheat bran, may be improved to some extent, but a level thereof is far from satisfactory.

The present inventors found that, in the wheat bran-containing processed food, a wheat bran odor is reduced, sourness is suppressed and also a feeling of absorbing saliva in a mouth is suppressed, and ease of eating is significantly improved by adjusting the respective contents of the ferulic acid and the p-coumaric acid relative to the content of insoluble dietary fibers to a specific ratio. The present invention has been completed based on these findings.

That is, the present invention is contemplated for providing a wheat bran-containing processed food in which both the odor peculiar to the wheat bran and the sourness thereof are suppressed, the wheat bran is hard to absorb the saliva in the mouth, and a dry feeling in the mouth is hard to sense.

A food form of the wheat bran-containing processed food of the present invention is not particularly limited, and specific examples include baked confectionery (preferably a form containing specific amounts of wheat bran, ferulic acid and p-coumaric acid in a biscuit, a cookie, a cracker, hardtack, a pretzel, a pie, cut bread or shortbread as described in “Seika Jiten (Confectionery Dictionary),” first edition, Oct. 30, 1981, p. 204), cereal food (generally referred to as Ready to eat, Breakfast cereal. In general, the cereal food is flake-shaped food obtained by cooking a grain raw material, cooling and then flaking the resultant material, molding and then expanding the resultant material, and subsequently drying and then roasting the resultant material. Liquid food such as milk is added thereto, and the resultant food is often eaten. The cereal food in the present invention means food in a state before milk or the like is added thereto, namely a form being sold in the form of the cereal food), granulated rice, seasoning food (for example, dressing, citron vinegar, soy sauce and spread), croutons, noodles and bread. Above all, from a viewpoint of further effectively developing advantageous effects of the present invention, the baked confectionery or the cereal food is preferable.

The wheat bran-containing processed food of the present invention contains insoluble dietary fibers derived from wheat bran. The wheat bran-containing processed food of the present invention may further contain, in addition to the insoluble dietary fibers derived from the wheat bran, one kind or two or more kinds of insoluble dietary fibers other than the insoluble dietary fibers derived from the wheat bran.

“Dietary fibers” mean a whole of hardly-digestible ingredients in food, the ingredients being not digested by a human digestive enzyme. Among them, one that is hard to be dissolved into water is called the insoluble dietary fibers. The kind of the insoluble dietary fibers other than the insoluble dietary fibers derived from the wheat bran are not particularly limited, and may be derived from grains, legumes, fruits, green goods or the like, or may be derived from shells of crustacea or cell walls of fungi.

From a viewpoint of effectively developing physiological action of the wheat bran, the ratio of the wheat-bran-derived insoluble dietary fibers to the whole of the insoluble dietary fibers contained in the wheat bran-containing processed food according to the present invention is preferably 30 mass % or more, more preferably 40 mass % or more, further preferably 50 mass % or more, and still further preferably 60 mass % or more. Moreover, the wheat bran-containing processed food according to the present invention ordinarily also contains insoluble dietary fibers derived from a raw material other than the wheat bran, for example, insoluble dietary fibers derived from farina such as wheat flour. Accordingly, the ratio of the wheat-bran-derived insoluble dietary fibers to the whole of the insoluble dietary fibers contained in the wheat bran-containing processed food according to the present invention is ordinarily 95 mass % or less, and may be 90 mass % or less, 80 mass % or less, or 75 mass % or less. The ratio of the wheat-bran-derived insoluble dietary fibers to the whole of the insoluble dietary fibers contained in the wheat bran-containing processed food according to the present invention is preferably 30 to 95 mass %, and may be 40 to 90 mass %, 50 to 80 mass %, or 60 to 75 mass %. Here, the “wheat-bran-derived insoluble dietary fibers” mean the insoluble dietary fibers derived from the wheat bran blended in producing the wheat bran-containing processed food.

The content of the insoluble dietary fibers in the wheat bran is ordinarily from about 40 mass % to about 50 mass %.

From a viewpoint of effectively developing physiological action of the insoluble dietary fibers, the content of the insoluble dietary fibers contained in the wheat bran-containing processed food of the present invention is preferably 1 mass % or more, more preferably 3 mass % or more, further preferably 4 mass % or more, and still further preferably 5 mass % or more. Moreover, from a viewpoint of eating properties, the content of the insoluble dietary fibers is preferably 20 mass % or less, more preferably 10 mass % or less, and further preferably 9 mass % or less. The content of the insoluble dietary fibers contained in the wheat bran-containing processed food of the present invention is preferably 1 to 20 mass %, more preferably 3 to 10 mass %, further preferably 4 to 10 mass %, and still further preferably 5 to 9 mass %. The content of the insoluble dietary fibers can be measured according to the method described in Examples as described later.

The content of the ferulic acid contained in the wheat bran-containing processed food of the present invention is 0.035 to 0.16 mass part, with respect to 100 mass parts of the content of the insoluble dietary fibers in the wheat bran-containing processed food of the present invention. Moreover, the content of the p-coumaric acid contained in the wheat bran-containing processed food of the present invention is 0.004 to 0.06 mass part, with respect to 100 mass parts of the content of the insoluble dietary fibers in the wheat bran-containing processed food of the present invention.

The odor of the wheat bran can be effectively suppressed, and the sourness caused by blending the wheat bran becomes hard to sense by adjusting the respective contents of the ferulic acid and the p-coumaric acid contained in the wheat bran-containing processed food according to the present invention within the above-described ranges. Further, the feeling of absorbing saliva in the mouth is suppressed and the dry feeling becomes hard to sense upon eating the processed food by adjusting the respective contents of the ferulic acid and the p-coumaric acid contained in the wheat bran-containing processed food within the above-described ranges. That is, a problem on food taste ordinarily of the wheat bran-containing processed food can be significantly improved. A method of adjusting the respective contents of the ferulic acid and the p-coumaric acid contained in the wheat bran-containing processed food within the above-described range is not particularly limited. For example, in producing the wheat bran-containing processed food, the respective contents of the ferulic acid and the p-coumaric acid can be adjusted within the above-described ranges by adding desired amounts of the ferulic acid and the p-coumaric acid.

From a viewpoint of improving the bran odor, the sourness and the feeling of absorbing saliva, the content of the ferulic acid contained in the wheat bran-containing processed food according to the present invention is preferably 0.05 mass part or more, and more preferably 0.06 mass part or more, with respect to 100 mass parts of the content of the insoluble dietary fibers in the wheat bran-containing processed food according to the present invention. Moreover, from a similar viewpoint, the content of the ferulic acid contained in the wheat bran-containing processed food according to the present invention is preferably 0.14 mass part or less, more preferably 0.12 mass part or less, further preferably 0.1 mass part or less, and still further preferably 0.08 mass part or less, with respect to 100 mass parts of the content of the insoluble dietary fibers in the wheat bran-containing processed food according to the present invention. Moreover, from a similar viewpoint, the content of the ferulic acid contained in the wheat bran-containing processed food according to the present invention is preferably 0.035 to 0.14 mass part, more preferably 0.035 to 0.12 mass part, further preferably 0.035 to 0.1 mass part, further preferably 0.035 to 0.08 mass part, further preferably 0.05 to 0.08 mass part, and still further preferably 0.06 to 0.08 mass part, with respect to 100 mass parts of the content of the insoluble dietary fibers in the wheat bran-containing processed food according to the present invention.

From a viewpoint of improving the bran odor, the sourness and the feeling of absorbing saliva, the content of the p-coumaric acid contained in the wheat bran-containing processed food according to the present invention is preferably 0.0065 mass part or more, more preferably 0.01 mass part or more, further preferably 0.018 mass part or more, and still further preferably 0.02 mass part or more, with respect to 100 mass parts of the content of the insoluble dietary fibers in the wheat bran-containing processed food according to the present invention. Moreover, from a similar viewpoint, the content of the p-coumaric acid contained in the wheat bran-containing processed food according to the present invention is preferably 0.028 mass part or less, and more preferably 0.026 mass part or less, with respect to 100 mass parts of the content of the insoluble dietary fibers in the wheat bran-containing processed food according to the present invention. Moreover, from a similar viewpoint, the content of the p-coumaric acid contained in the wheat bran-containing processed food according to the present invention is preferably 0.0065 to 0.028 mass part, more preferably 0.01 to 0.026 mass part, further preferably 0.018 to 0.026 mass part, and still further preferably 0.02 to 0.026 mass part, with respect to 100 mass parts of the content of the insoluble dietary fibers in the wheat bran-containing processed food according to the present invention.

The contents of the ferulic acid and the p-coumaric acid can be measured according to the method described in Examples as mentioned later.

From a viewpoint of improving the bran odor, the sourness and the feeling of absorbing saliva, the ratio of the content of the ferulic acid to the content of the p-coumaric acid ((ferulic acid)/(p-coumaric acid), mass ratio) contained in the wheat bran-containing processed food according to the present invention is preferably 2.0 or more, more preferably 2.5 or more, further preferably 2.7 or more, and still further preferably 2.9 or more. Moreover, from a similar viewpoint, the above-described ratio is preferably 9.0 or less, more preferably 6.0 or less, further preferably 3.5 or less, and still further preferably 3.3 or less. Moreover, from a similar viewpoint, the above-described ratio is preferably 2.0 to 9.0, more preferably 2.5 to 6.0, further preferably 2.7 to 3.5, and still further preferably 2.9 to 3.3.

From a viewpoint of the storage stability, the moisture content (water content) in the wheat bran-containing processed food of the present invention is preferably 20 mass % or less, more preferably 15 mass % or less, and further preferably 10 mass % or less. Moreover, from a viewpoint of the food texture, the moisture content in the wheat bran-containing processed food of the present invention is preferably 3 mass % or more, more preferably 4 mass % or more, and further preferably 5 mass % or more. More specifically, the moisture content in the wheat bran-containing processed food of the present invention is preferably 3 to 20 mass %, more preferably 4 to 15 mass %, and further preferably 5 to 10 mass %.

From the viewpoint of the storage stability, water activity of the wheat bran-containing processed food of the present invention is preferably 0.8 or less, more preferably 0.7 or less, and further preferably 0.6 or less.

The method of producing the wheat bran-containing processed food of the present invention is not particularly limited. In an ordinary preparation method thereof in an intended food form, the food can be obtained by blending the wheat bran, the ferulic acid, the p-coumaric acid and the like in such a manner that the contents of the insoluble dietary fibers, the ferulic acid, the p-coumaric acid and the like in the wheat bran-containing processed food to be obtained satisfy the specifications of the present invention. As the wheat bran, the bran obtained by milling hulls of wheat is preferably used. The wheat bran is commercially available, and Wheat Bran DF (trade name, manufactured by Nisshin Pharma Inc.) and Wheat Bran (trade name, manufactured by NIPPON FLOUR MILLS Co., Ltd.) can be used, for example. Moreover, the ferulic acid and the p-coumaric acid are commercially available.

From a viewpoint of the physiological action, with regard to the blending amount of the wheat bran into the wheat bran-containing processed food according to the present invention, the wheat bran is blended in such a manner that the content thereof becomes preferably 5 mass % or more, more preferably 8 mass % or more, and further preferably 10 mass % or more in the wheat bran-containing processed food. Further, from a viewpoint of the flavor, the wheat bran is blended in such a manner that the content thereof becomes preferably 40 mass % or less, more preferably 20 mass % or less, further preferably 17 mass % or less, and still further preferably 15 mass % or less in the wheat bran-containing processed food.

When the wheat bran-containing processed food according to the present invention is the baked confectionery, it can be obtained by mixing at least the farina (preferably wheat flour, more preferably weak flour), the wheat bran, the ferulic acid and the p-coumaric acid in specific amounts to prepare dough, and baking the dough in an oven or the like, for example. In preparing the above-described dough, it is preferable to blend fat, a saccharide and the like which can be used as raw materials in preparing ordinary baked confectionery. Moreover, an egg, powdered milk, milk, coconut milk, salt, powder, a seasoning, baking powder, a pH adjuster, an antioxidant, an emulsifying agent, a flavoring agent, vitamins, protein, starch, water and the like may be blended as desired.

Moreover, when the wheat bran-containing processed food according to the present invention is the cereal food (Breakfast cereal), the cereal food can be obtained by cooking a grain raw material, cooling and then flaking the resultant material, molding and then expanding the resultant material by an extruder, and subsequently drying and then roasting the resultant material by a conventional method, for example. The contents of the insoluble dietary fibers, the ferulic acid, the p-coumaric acid and the like in the prepared cereal food can be adjusted within the ranges specified in the present invention by blending the wheat bran, the ferulic acid, the p-coumaric acid and the like in the above-described production process. Specific examples of the above-described grain raw material include corn, rice, brown rice, wheat, barley, rye, oats, Job's tears, naked barley, buckwheat, foxtail millet, common millet, Japanese millet, kaoliang (milo) and amaranthus. Moreover, legumes such as a soybean, an adzuki bean, a green pea, a broad bean, and a kidney bean can also be used as the grain raw material. In preparing the above-described dough, for example, an emulsifying agent, a binder, saccharides, a natural or artificial sweetener, chocolate, cocoa, salt, a seasoning, spice, fats and oils, a coloring agent, a dehydrated vegetable, a dehydrated fruit, nuts, vitamins, a mineral additive, dietary fibers, protein, water and the like can be blended, when necessary.

In the wheat bran-containing processed food according to the present invention, both the odor peculiar to the wheat bran and the sourness thereof are reduced, and the saliva is hard to be absorbed in the mouth and the dry feeling is hard to sense.

With regard to the above-mentioned embodiment, the present invention discloses the wheat bran-containing processed foods as described below.

<1>

A wheat bran-containing processed food, containing:

insoluble dietary fibers;

ferulic acid; and

p-coumaric acid;

wherein the content of the ferulic acid is 0.035 to 0.16 mass part, with respect to 100 mass parts of the content of the insoluble dietary fibers; and

wherein the content of the p-coumaric acid is 0.004 to 0.06 mass part, with respect to 100 mass parts of the content of the insoluble dietary fibers.

<2>

The wheat bran-containing processed food according to the item <1>, wherein the wheat bran-containing processed food is baked confectionery or cereal food.

<3>

The wheat bran-containing processed food according to the item <1> or <2>, wherein the ratio of the wheat-bran-derived insoluble dietary fibers to the whole of the insoluble dietary fibers contained in the wheat bran-containing processed food is preferably 30 mass % or more, more preferably 40 mass % or more, further preferably 50 mass % or more, and still further preferably 60 mass % or more.

<4>

The wheat bran-containing processed food according to any one of the items <1> to <3>, wherein the ratio of the wheat-bran-derived insoluble dietary fibers to the whole of the insoluble dietary fibers contained in the wheat bran-containing processed food is ordinary 95 mass % or less, and may be 90 mass % or less, 80 mass % or less, or 75 mass % or less.

<5>

The wheat bran-containing processed food according to any one of the items <1> to <4>, wherein the ratio of the wheat-bran-derived insoluble dietary fibers to the whole of the insoluble dietary fibers contained in the wheat bran-containing processed food is preferably 30 to 95 mass %, and may be 40 to 90 mass %, 50 to 80 mass %, or 60 to 75 mass %.

<6>

The wheat bran-containing processed food according to any one of the items <1> to <5>, wherein the content of the insoluble dietary fibers in the wheat bran is preferably 40 to 50 mass %.

<7>

The wheat bran-containing processed food according to any one of the items <1> to <6>, wherein the content of the insoluble dietary fibers contained in the wheat bran-containing processed food is preferably 1 mass % or more, more preferably 3 mass % or more, further preferably 4 mass % or more, and still further preferably 5 mass % or more.

<8>

The wheat bran-containing processed food according to any one of the items <1> to <7>, wherein the content of the insoluble dietary fibers contained in the wheat bran-containing processed food is preferably 20 mass % or less, more preferably 10 mass % or less, and further preferably 9 mass % or less.

<9>

The wheat bran-containing processed food according to any one of the items <1> to <8>, wherein the content of the insoluble dietary fibers contained in the wheat bran-containing processed food is preferably 1 to 20 mass %, more preferably 3 to 10 mass %, further preferably 4 to 10 mass %, and still further preferably 5 to 9 mass %.

<10>

The wheat bran-containing processed food according to any one of the items <1> to <9>, wherein the content of the ferulic acid contained in the wheat bran-containing processed food is preferably 0.05 mass part or more, and more preferably 0.06 mass part or more, with respect to 100 mass parts of the content of the insoluble dietary fibers.

<11>

The wheat bran-containing processed food according to any one of the items <1> to <10>, wherein the content of the ferulic acid contained in the wheat bran-containing processed food is preferably 0.14 mass part or less, more preferably 0.12 mass part or less, further preferably 0.1 mass part or less, and still further preferably 0.08 mass part or less, with respect to 100 mass parts of the content of the insoluble dietary fibers.

The wheat bran-containing processed food according to any one of the items <1> to <11>, wherein the content of the ferulic acid contained in the wheat bran-containing processed food is preferably 0.035 to 0.14 mass part, more preferably 0.035 to 0.12 mass part, further preferably 0.035 to 0.1 mass part, further preferably 0.035 to 0.08 mass part, further preferably 0.05 to 0.08 mass part, and still further preferably 0.06 to 0.08 mass part, with respect to 100 mass parts of the content of the insoluble dietary fibers.

<13>

The wheat bran-containing processed food according to any one of the items <1> to <12>, wherein the content of the p-coumaric acid contained in the wheat bran-containing processed food is preferably 0.0065 mass part or more, more preferably 0.01 mass part or more, further preferably 0.018 mass part or more, and still further preferably 0.02 mass part or more, with respect to 100 mass parts of the content of the insoluble dietary fibers.

<14>

The wheat bran-containing processed food according to any one of the items <1> to <13>, wherein the content of the p-coumaric acid contained in the wheat bran-containing processed food is preferably 0.028 mass part or less, and more preferably 0.026 mass part or less, with respect to 100 mass parts of the content of the insoluble dietary fibers.

<15>

The wheat bran-containing processed food according to any one of the items <1> to <14>, wherein the content of the p-coumaric acid contained in the wheat bran-containing processed food is preferably 0.0065 to 0.028 mass part, more preferably 0.01 to 0.026 mass part, further preferably 0.018 to 0.026 mass part, and still further preferably 0.02 to 0.026 mass part, with respect to 100 mass parts of the content of the insoluble dietary fibers.

<16>

The wheat bran-containing processed food according to any one of the items <1> to <15>, wherein the ratio of the content of the ferulic acid to the content of the p-coumaric acid ((ferulic acid)/(p-coumaric acid), mass ratio) contained in the wheat bran-containing processed food is preferably 2.0 or more, more preferably 2.5 or more, further preferably 2.7 or more, and still further preferably 2.9 or more.

<17>

The wheat bran-containing processed food according to any one of the items <1> to <16>, wherein the ratio of the content of the ferulic acid to the content of the p-coumaric acid ((ferulic acid)/(p-coumaric acid), mass ratio) contained in the wheat bran-containing processed food is preferably 9.0 or less, more preferably 6.0 or less, further preferably 3.5 or less, and still further preferably 3.3 or less.

<18>

The wheat bran-containing processed food according to any one of the items <1> to <17>, wherein the ratio of the content of the ferulic acid to the content of the p-coumaric acid ((ferulic acid)/(p-coumaric acid), mass ratio) contained in the wheat bran-containing processed food is preferably 2.0 to 9.0, more preferably 2.5 to 6.0, further preferably 2.7 to 3.5, and still further preferably 2.9 to 3.3.

<19>

The wheat bran-containing processed food according to any one of the items <1> to <18>, wherein the moisture content of the wheat bran-containing processed food is preferably 20 mass % or less, more preferably 15 mass % or less, and further preferably 10 mass % or less.

<20>

The wheat bran-containing processed food according to any one of the items <1> to <19>, wherein the moisture content of the wheat bran-containing processed food is preferably 3 mass % or more, more preferably 4 mass % or more, and further preferably 5 mass % or more.

<21>

The wheat bran-containing processed food according to any one of the items <1> to <20>, wherein the moisture content of the wheat bran-containing processed food is preferably 3 to 20 mass %, more preferably 4 to 15 mass %, and further preferably 5 to 10 mass %.

<22>

The wheat bran-containing processed food according to any one of the items <1> to <21>, wherein water activity of the wheat bran-containing processed food is preferably 0.8 or less, more preferably 0.7 or less, and further preferably 0.6 or less.

<23>

The wheat bran-containing processed food according to any one of the items <1> to <22>, wherein the wheat bran-containing processed food is produced by blending the wheat bran in producing the wheat bran-containing processed food in such a manner that the content of the wheat bran in the wheat bran-containing processed food becomes preferably 5 mass % or more, more preferably 8 mass % or more, and further preferably 10 mass % or more.

<24>

The wheat bran-containing processed food according to any one of the items <1> to <23>, wherein the wheat bran-containing processed food is produced by blending the wheat bran in producing the wheat bran-containing processed food in such a manner that the content of the wheat bran in the wheat bran-containing processed food becomes preferably 40 mass % or less, more preferably 20 mass % or less, further preferably 17 mass % or less, and still further preferably 15 mass % or less.

<25>

The wheat bran-containing processed food according to any one of the items <1> to <24>, wherein the wheat bran-containing processed food is produced by blending the wheat bran in producing the wheat bran-containing processed food in such a manner that the content of the wheat bran in the wheat bran-containing processed food becomes preferably 5 to 40 mass %, more preferably 8 to 20 mass %, further preferably 10 to 17 mass %, and still further preferably 10 to 15 mass %.

<26>

The wheat bran-containing processed food according to any one of the items <1> to <25>, wherein the wheat bran-containing processed food is baked confectionery, and the baked confectionery is obtained by mixing at least farina (preferably wheat flour, more preferably weak flour), the wheat bran, the ferulic acid and the p-coumaric acid to prepare dough, and baking the dough.

<27>

The wheat bran-containing processed food according to any one of the items <1> to <25>, wherein the wheat bran-containing processed food is cereal food, and the cereal food is obtained by cooking a grain raw material, cooling and then flaking the resultant material, molding and then expanding the resultant material, and subsequently drying and then roasting the resultant material.

<28>

The wheat bran-containing processed food according to the item <27>, wherein the grain raw material is derived from one kind or two or more kinds selected from the group consisting of corn, rice, brown rice, wheat, barley, rye, oats, Job's tears, naked barley, buckwheat, foxtail millet, common millet, Japanese millet, kaoliang (milo), amaranthus, a soybean, an adzuki bean, a green pea, a broad bean, and a kidney bean.

### EXAMPLE

The present invention will be described in more detail based on the following examples, but the invention is not intended to be limited to the following Examples.

### [Measurement Method]

### (Measurement of Content of Insoluble Dietary Fibers)

The amount of insoluble dietary fibers was measured by the modified Prosky method described in AOAC Method 991.42. Specifically the amount was measured by the following method.

A sample was processed using a homogenizer, and then sieved using a 10-mesh sieve to obtain powder having a particle size of 2 mm or less. Then, 125 mL of petroleum ether was added to 5 g of the obtained powder sample, and the resultant mixture was allowed to stand for 15 minutes while the mixture was occasionally stirred, and then centrifuged (2150 G, 10 minutes), and the resulting supernatant was poured into a glass filter G-3. Further, similar operation was repeated twice, and finally a total amount was poured into the glass filter, a residue was air-dried, and then the resultant defatted sample was weighed. Then, 1 g of the defatted sample was collected into a 500 mL-volume tall beaker, and then, 50 mL of 0.08 M phosphate buffer solution having pH of 6.0, and 0.1 mL of thermostable α-amylase (trade name: Termacyl 120L, manufactured by NovoZymes A/S) were added thereto. The resultant mixture was allowed to stand in a water bath at 95° C. for 30 minutes while the mixture was shaken at an interval of 5 minutes, and allowed to cool for 10 minutes at room temperature, and then 0.275 M sodium hydroxide solution was added thereto and adjusted to pH 7.5. Then, 0.1 mL of protease (manufactured by Sigma-Aldrich Corporation) solution adjusted to be a concentration of 50 mg/mL by dissolving the protease into 0.08 M phosphate buffer solution adjusted to pH 6.0 was added thereto. Activity of the added protease was 500 U/mL. Then, the resultant mixture was shaken at 60° C. for 30 minutes, allowed to cool at room temperature for 10 minutes, and then adjusted to pH 4.3 using 0.325 M hydrochloric acid. Then, 0.1 mL of amyloglucosidase (trade name: Amyloglucosidase solution from Aspergillus niger, manufactured by Sigma-Aldrich Corporation) was added thereto, and the resultant mixture was shaken at 60° C. for 30 minutes. Filtration was made using a crucible type glass 2G2, a product obtained by drying the residue at 105° C. overnight was weighed, and taken as an amount of insoluble dietary fibers. The content of the insoluble dietary fibers in the sample was calculated based on thus obtained amount of insoluble dietary fibers.

(Measurement of Content of Ferulic Acid and p-Coumaric Acid)

Extraction of Polyphenol

The extraction of the polyphenol was carried out according to the method described below, referring to the method of Zhou et al. (Kequan Zhou, Lan Su, and Liangli (Lucy) Yu., Phytochemicals and Antioxidant Properties in Wheat Bran. J. Agric. Food Chem., 52, 6108-6114 (2004)), the method of Anson et al. (Nuria Mateo Ansonra, Bioprocessing of wheat bran improves in vitro bioaccessibility and colonic metabolism of phenolic compounds, J. Agric. Food Chem., 57, 6148-6155 (2009)), and the method described in JP-A-2010-63454.

In a centrifuge tube, 1.0 g of a sample was weighed, 15 mL of aqueous acetone (50 v/v %) was added thereto, and the resultant mixture was shaken at room temperature for 15 hours. Then, the mixture was centrifuged at 10,000×g for 10 minutes, and the obtained supernatant was collected therein. The equal amount of diethyl ether:ethyl acetate=1:1 (volume ratio) was added to the supernatant, and liquid separation was carried out to collect the diethyl ether-ethyl acetate layer. These liquid separation and collection operation were repeated 3 times. The solvent in the thus obtained diethyl ether-ethyl acetate layer was completely distilled off by an evaporator to obtain an extract (total polyphenol extract) containing free polyphenol.

Quantitative Determination of Ferulic Acid and p-Coumaric Acid

The total polyphenol extract obtained as described above was dissolved into 2 mL of methanol for high performance liquid chromatography (HPLC) to quantitatively determine ferulic acid and p-coumaric acid by HPLC. A calibration curve for the peak area value and the concentration was preliminarily prepared by using commercially available ferulic acid and p-coumaric acid as a reference material, and the ferulic acid and the p-coumaric acid were quantitatively determined based on this calibration curve.

Analysis conditions in the HPLC are as follows.

Column: COSMOSIL 5C18-MS-II (150 mm×4.6 mm)
Mobile phase A: 0.025% TFA-containing water
Mobile phase B: 0.025% TFA-containing acetonitrile
Gradient conditions:

<Elapsed time> <Conc. of mobile phase B (vol. %)>

0→5 min. 5%→9%

5→15 min. 9%→9%

15→22 min. 9%→11%

22→38 min. 11%→18%

### Column Temperature: 40° C.

Detection wavelength: UV 280 nm
Flow rate: 0.8 mL/min
Injection amount: 10 μL
Reference material: ferulic acid (manufactured by MP Biomedicals, LLC), p-coumaric acid (manufactured by LKT Laboratories, Inc.)

### [Preparation Example] Preparation of Baked Confectionery

Each raw material was mixed in blending amounts (unit: mass part) described in Table 1 below, and subsequently ferulic acid (manufactured by MP Biomedicals, LLC) and p-coumaric acid (manufactured by LKT Laboratories, Inc.) were mixed thereto in blending amounts (unit: mass part on the basis same with the basis in Table 1) described in Table 2. The obtained dough was baked to obtain baked confectionery of Products 1 to 8 according to the present invention and Comparative Products 1 to 13.

TABLE 1

| | Blending amount (mass part) | | | |
|---|---|---|---|---|
| | | Product according to | Product according to | |
| | | the present invention 7 | the present invention 8 | Comparative Product 11 |
| Raw materials | Others | Comparative Product 9 | Comparative Product 10 | Comparative Product 12 |
| Margarine (trade name: Cherica Gold E(A), | 89.4 | 96.4 | 92.9 | 87.8 |
| manufactured by Kao Corporation) | | | | |
| Sodium bicarbonate (manufactured by | 0.7 | 0.7 | 0.7 | 0.7 |
| Wako Pure Chemical Industries, Ltd.) | | | | |
| Whole hen's egg | 61.9 | 66.7 | 64.3 | 60.8 |
| Ammonium carbonate (manufactured by | 2.8 | 3.0 | 2.9 | 2.7 |
| Wako Pure Chemical Industries, Ltd.) | | | | |
| Reduced sugar syrup (trade name: Sweet OL, | 206.3 | 222.4 | 214.3 | 202.6 |
| manufactured by B Food Science Co., Ltd.) | | | | |
| Wheat flour (trade name: Violet, manufactured by | 505.4 | 544.9 | 525.0 | 496.4 |
| Nisshin Flour Milling Inc.) | | | | |
| Wheat bran (trade name: Wheat Bran DF, | 133.0 | 66.5 | 99.8 | 151.1 |
| manufactured by Nisshin Pharma Inc.) | | | | |
| Content of insoluble dietary fibers in wheat bran: | | | | |
| 43.6 mass % | | | | |
| Blending amount of wheat bran (mass %) | 13.3 | 6.6 | 10.0 | 15.1 |

A method of preparing the above-described baked confectionery is described in more detail.

In HOBART mixer N50 MIXER manufactured by HOBART GmbH, margarine, reduced sugar syrup, ammonium carbonate as baking powder, and sodium bicarbonate were weighed and put therein, and the resultant mixture was mixed at a low speed for 30 seconds, and then mixed at a medium speed.

Further, while the resultant mixture was stirred at a low speed for 30 seconds, whole hen's egg beaten was added thereto in 2 parts. After a first part of beaten egg was added thereto, the resultant mixture was stirred at a low speed for 30 seconds. Subsequently, a second part of beaten egg was added thereto, and the resultant mixture was stirred at a low speed for 30 seconds. After oil adhered to the wall of the mixer was scraped off, the resultant mixture was stirred at a low speed for 30 seconds.

Subsequently, wheat flour was blended therein, the resultant mixture was stirred at a low speed for 45 seconds. Then wheat bran was blended therein, and the resultant mixture was stirred at a low speed for 45 seconds.

Finally, ferulic acid (manufactured by MP Biomedicals, LLC) and p-coumaric acid (manufactured by LKT Laboratories, Inc.) were added thereto, and the resultant mixture was stirred at a low speed for 45 seconds and sufficiently mixed.

The dough obtained as described above was packed into rectangular baking pans and set them in line on a top plate on which a release paper was placed. As the baking pan, one made of metal and having a dimension of vertical×horizontal×height: 80 mm×20 mm×15 mm was used.

Subsequently, baking was performed under the following baking conditions to obtain baked confectionery.

Baking temperature: upper flame 180° C./lower flame 180° C.

Baking time: 10 minutes and 30 seconds

Moisture contents in all of the baked confectionery after being baked were within the range of 4 to 7 mass %.

In addition, no ferulic acid was blended in the dough of Comparative Products 1 and 2, and no p-coumaric acid was blended in the dough of Comparative Products 3, 5, 6, 8, 11 and 12. Moreover, neither the ferulic acid nor the p-coumaric acid was blended in the reference product.

The thus obtained baked confectionery which was allowed to stand at room temperature for one day was taken as a sample, and the contents of the insoluble dietary fibers, the ferulic acid and the p-coumaric acid in the baked confectionery were measured according to the above-described measurement method.

### [Test Example] Sensory Evaluation

The baked confectionery which was prepared in the above-described Preparation Example and was allowed to stand at room temperature for one day was taken as a sample, and the bran odor, sourness, and the feeling of absorbing saliva were evaluated based on the following evaluation criteria. Each evaluation was conducted by two specialist panels. All evaluation results by the two specialist panels were agreed.

### (Bran Odor)

4: Almost no sensing of bran odor.
3: Some sensing of bran odor, but not significantly concerned.
2: Sensing of bran odor.
1: Strong sensing of bran odor (Equivalent to the reference product).

### (Sourness)

4: No sensing of sourness.
3: Almost no sensing of sourness.
2: Some sensing of sourness.
1: Sensing of sourness (Equivalent to the reference product).

### (Feeling of Absorbing Saliva)

4: No sense of saliva being absorbed to naturally allow swallowing.
3: Less absorption of saliva, and not concerned about a dry feeling in a mouth, either.
2: Saliva being absorbed, and a dry feeling being felt in a mouth.
1: Strong feeling of absorbing saliva, and a dry feeling being strongly felt in a mouth (Equivalent to the reference product).

The results are shown in Table 2 below.

TABLE 2

| | Reference | Products according to the present invention | | | | | | | |
|---|---|---|---|---|---|---|---|---|---|
| | product | 1 | 2 | 3 | 4 | 5 | 6 | 7 | 8 |
| Blending amount of | 0 | 0.0324 | 0.0023 | 0.0023 | 0.0023 | 0.0324 | 0.0927 | 0.0350 | 0.0390 |
| ferulic acid (mass part) | | | | | | | | | |
| Blending amount of | 0 | 0.0148 | 0.0060 | 0.0022 | 0.0006 | 0.0173 | 0.0374 | 0.0172 | 0.0184 |
| p-coumaric acid (mass part) | | | | | | | | | |
| Content of ferulic acid | 0.00264 | 0.00589 | 0.00287 | 0.00287 | 0.00287 | 0.00589 | 0.01192 | 0.00614 | 0.00654 |
| in baked confectionery | | | | | | | | | |
| (mass %) | | | | | | | | | |
| Content of p-coumaric acid | 0.00027 | 0.00176 | 0.00087 | 0.00049 | 0.00033 | 0.00200 | 0.00401 | 0.00199 | 0.00211 |
| in baked confectionery | | | | | | | | | |
| (mass %) | | | | | | | | | |
| Content of insoluble dietary | 7.80 | 7.80 | 7.80 | 7.80 | 7.80 | 7.80 | 7.80 | 5.86 | 7.10 |
| fibers in baked confectionery | | | | | | | | | |
| (mass %) | | | | | | | | | |
| Ratio of wheat-bran-derived | 72.70 | 72.70 | 72.70 | 72.70 | 72.70 | 72.70 | 72.70 | 64.53 | 70.69 |
| insoluble dietary fibers to | | | | | | | | | |
| the insoluble dietary fibers | | | | | | | | | |
| contained in baked confectionery | | | | | | | | | |
| (mass %) | | | | | | | | | |
| Content of ferulic acid to | 0.0339 | 0.0755 | 0.0368 | 0,0368 | 0.0368 | 0.0755 | 0.1528 | 0.1047 | 0.0922 |
| 100 mass parts of insoluble | | | | | | | | | |
| dietary fibers content (mass | | | | | | | | | |
| part) | | | | | | | | | |
| Content of p-coumaric acid to | 0.0034 | 0.0225 | 0.0112 | 0.0063 | 0.0042 | 0.0256 | 0.0514 | 0.0340 | 0.0298 |
| 100 mass parts of insoluble | | | | | | | | | |
| dietary fibers content (mass | | | | | | | | | |
| part) | | | | | | | | | |
| Ratio of ferulic acid content | 10.0 | 3.4 | 3.3 | 5.8 | 8.8 | 2.9 | 3.0 | 3.1 | 3.1 |
| to p-coumaric acid content | | | | | | | | | |
| ((ferulic acid)/(p-coumaric | | | | | | | | | |
| acid)) | | | | | | | | | |
| Bran odor | 1 | 4 | 4 | 4 | 4 | 4 | 3 | 4 | 4 |
| Sourness | 1 | 3 | 4 | 3 | 3 | 4 | 3 | 4 | 3 |
| Feeling of absorbing saliva | 1 | 4 | 4 | 4 | 4 | 4 | 3 | 3 | 3 |

| | Comparative Products | | | | | | |
|---|---|---|---|---|---|---|---|
| | 1 | 2 | 3 | 4 | 5 | 6 | 7 |
| Blending amount of | 0.0000 | 0.0000 | 0.0023 | 0.1288 | 0.0324 | 0.0927 | 0.1529 |
| ferulic acid (mass | | | | | | | |
| part) | | | | | | | |
| Blending amount of | 0.0060 | 0.0016 | 0.0000 | 0.0077 | 0.0000 | 0.0000 | 0.0574 |
| p-coumaric acid (mass | | | | | | | |
| part) | | | | | | | |
| Content of ferulic acid | 0.00264 | 0.00264 | 0.00287 | 0.01553 | 0.00589 | 0.01192 | 0.01794 |
| in baked confectionery | | | | | | | |
| (mass %) | | | | | | | |
| Content of p-coumaric acid | 0.00087 | 0.00043 | 0.00027 | 0.00104 | 0.00027 | 0.00027 | 0.00601 |
| in baked confectionery | | | | | | | |
| (mass %) | | | | | | | |
| Content of insoluble dietary | 7.80 | 7.80 | 7.80 | 7.80 | 7.80 | 7.80 | 7.80 |
| fibers in baked confectionery | | | | | | | |
| (mass %) | | | | | | | |
| Ratio of wheat-bran-derived | 72.70 | 72.70 | 72.70 | 72.70 | 72.70 | 72.70 | 72.70 |
| insoluble dietary fibers to | | | | | | | |
| the insoluble dietary fibers | | | | | | | |
| contained in baked confectionery | | | | | | | |
| (mass %) | | | | | | | |
| Content of ferulic acid to 100 mass | 0.0339 | 0.0339 | 0.0368 | 0.1991 | 0.0755 | 0.1528 | 0.2300 |
| parts of insoluble dietary fibers | | | | | | | |
| content (mass part) | | | | | | | |
| Content of p-coumaric acid to | 0.0112 | 0.0055 | 0.0034 | 0.0133 | 0.0034 | 0.0034 | 0.0771 |
| 100 mass parts of insoluble | | | | | | | |
| dietary fibers content (mass | | | | | | | |
| part) | | | | | | | |
| Ratio of ferulic acid content | 3.0 | 6.2 | 10.8 | 15.0 | 22.2 | 44.9 | 3.0 |
| to p-coumaric acid content | | | | | | | |
| ((ferulic acid)/(p-coumaric | | | | | | | |
| acid)) | | | | | | | |
| Bran odor | 2 | 3 | 2 | 2 | 2 | 2 | 2 |
| Sourness | 1 | 2 | 1 | 1 | 1 | 1 | 2 |
| Feeling of absorbing saliva | 2 | 2 | 3 | 3 | 3 | 3 | 3 |

| | Comparative Products | | | | | |
|---|---|---|---|---|---|---|
| | 8 | 9 | 10 | 11 | 12 | 13 |
| Blending amount of | 0.1529 | 0.1764 | 0.1884 | 0.0921 | 0.1225 | 0.0324 |
| ferulic acid (mass | | | | | | |
| part) | | | | | | |
| Blending amount of | 0.0000 | 0.0671 | 0.0709 | 0.0000 | 0.0000 | 0.0909 |
| p-coumaric acid (mass | | | | | | |
| part) | | | | | | |
| Content of ferulic acid | 0.01794 | 0.02028 | 0.02149 | 0.01183 | 0.01487 | 0.00589 |
| in baked confectionery | | | | | | |
| (mass %) | | | | | | |
| Content of p-coumaric acid | 0.00027 | 0.00698 | 0.00736 | 0.00027 | 0.00027 | 0.00936 |
| in baked confectionery | | | | | | |
| (mass %) | | | | | | |
| Content of insoluble dietary | 7.80 | 5.86 | 7.10 | 8.59 | 8.59 | 7.80 |
| fibers in baked confectionery | | | | | | |
| (mass %) | | | | | | |
| Ratio of wheat-bran-derived | 72.70 | 64.53 | 70.69 | 75.79 | 75.79 | 72.70 |
| insoluble dietary fibers to | | | | | | |
| the insoluble dietary fibers | | | | | | |
| contained in baked confectionery | | | | | | |
| (mass %) | | | | | | |
| Content of ferulic acid to | 0.2300 | 0.3458 | 0.3028 | 0.1377 | 0.1730 | 0.0755 |
| 100 mass parts of insoluble | | | | | | |
| dietary fibers content (mass | | | | | | |
| part) | | | | | | |
| Content of p-coumaric acid to | 0.0034 | 0.1190 | 0,1037 | 0.0032 | 0.0032 | 0.1200 |
| 100 mass parts of insoluble | | | | | | |
| dietary fibers content (mass | | | | | | |
| part) | | | | | | |
| Ratio of ferulic acid content | 67.6 | 2.9 | 2.9 | 43.1 | 54.1 | 0.6 |
| to p-coumaric acid content | | | | | | |
| ((ferulic acid)/(p-coumaric | | | | | | |
| acid)) | | | | | | |
| Bran odor | 2 | 1 | 2 | 2 | 2 | 2 |
| Sourness | 1 | 2 | 2 | 1 | 1 | 2 |
| Feeling of absorbing saliva | 2 | 2 | 2 | 2 | 1 | 1 |

When the content of the p-coumaric acid was raised up to the range specified in the present invention, the bran odor, the sourness and the feeling of absorbing saliva tended to improve in comparison with the reference product. However, in this case, when the content of the ferulic acid was lower than the amount specified in the present invention, a satisfactory improvement was not achieved (Comparative Products 1 and 2). In addition, when the content of the ferulic acid was higher than the amount specified in the present invention, the product gave poor results in both evaluations of the bran odor and the sourness (Comparative Product 4). Moreover, when the content of the ferulic acid was raised up to the range specified in the present invention, a trend of improvement in the bran odor and the feeling of absorbing saliva was recognized. However, in this case, when the content of the p-coumaric acid was lower than the amount specified in the present invention, the satisfactory improvement was not achieved (Comparative Products 3, 5, 6 and 11), either. Moreover, even if the content of the ferulic acid was within the range specified in the present invention, when the content of the p-coumaric acid was higher than the amount specified in the present invention, the products gave poor results in the bran odor, the sourness and the feeling of absorbing saliva (Comparative Product 13). Moreover, when both the contents of the ferulic acid and the p-coumaric acid were not within the ranges specified in the present invention, the products also gave poor results in two or more evaluation items of the bran odor, the sourness and the feeling of absorbing saliva (Comparative Products 7 to 10 and 12).

In contrast, Products 1 to 8 according to the present invention in which both of the respective contents of the ferulic acid and the p-coumaric acid were within the range specified in the present invention, the bran odor was reduced, the sourness was suppressed, and also absorption of saliva was low and the dry feeling was not sensed in the mouth. That is, Products 1 to 8 according to the present invention had a flavor and mouth feel with good ease of eating, while the products contain the wheat bran.

Having described our invention as related to this embodiments, it is our intention that the invention not be limited by any of the details of the description, unless otherwise specified, but rather be construed broadly within its spirit and scope as set out in the accompanying claims.

This application claims priority on Patent Application No. 2014-133357 filed in Japan on Jun. 27, 2014, which is entirely herein incorporated by reference.

1. A wheat bran-containing processed food, comprising:
insoluble dietary fibers;
ferulic acid; and
p-coumaric acid;
wherein the content of the ferulic acid is 0.035 to 0.16 mass part, with respect to 100 mass parts of the content of the insoluble dietary fibers; and
wherein the content of the p-coumaric acid is 0.004 to 0.06 mass part, with respect to 100 mass parts of the content of the insoluble dietary fibers.

2. The wheat bran-containing processed food according to claim 1, wherein the wheat bran-containing processed food is baked confectionery or cereal food.

3. The wheat bran-containing processed food according to claim 1, wherein the content of the insoluble dietary fibers contained in the wheat bran-containing processed food is 1 to 20 mass %.

4. The wheat bran-containing processed food according to claim 3, wherein the content of the insoluble dietary fibers contained in the wheat bran-containing processed food is 4 to 10 mass %.

5. The wheat bran-containing processed food according to claim 1, wherein the ratio of the wheat-bran-derived insoluble dietary fibers to the whole of the insoluble dietary fibers contained in the wheat bran-containing processed food is 30 to 95 mass %.

6. The wheat bran-containing processed food according to claim 1, wherein the content of the ferulic acid contained in the wheat bran-containing processed food is 0.035 to 0.12 mass part, with respect to 100 mass parts of the content of the insoluble dietary fibers.

7. The wheat bran-containing processed food according to claim 1, wherein the content of the p-coumaric acid contained in the wheat bran-containing processed food is 0.01 to 0.026 mass part, with respect to 100 mass parts of the content of the insoluble dietary fibers.

8. The wheat bran-containing processed food according to claim 1, wherein the ratio of the content of the ferulic acid to the content of the p-coumaric acid contained in the wheat bran-containing processed food satisfies (ferulic acid)/(p-coumaric acid)=2.0 to 9.0 in terms of a mass ratio.

9. The wheat bran-containing processed food according to claim 1, wherein the moisture content of the wheat bran-containing processed food is 3 to 20 mass %.
